(19) United States
(12) Patent Application Publication
(10) Pub. No.: US 2005/0125525 A1
(43) Pub. Date: Jun. 9, 2005

(54) Method, system, and storage medium for providing intelligent distribution of software and files

(75) Inventors: Nianjun Zhou, Somers, NY (US); Ramesh Subramanian, North Haven, CT (US)

Correspondence Address: CANTOR COLBURN, LLP, 55 GRIFFIN ROAD SOUTH, BLOOMFIELD, CT, 06002, US

(73) Assignee: International Business Machines, Armonk, NY (US)

(21) Appl. No.: 10/731,286

(22) Filed: Dec. 9, 2003

(51) Int. Cl. G06F 15/173; G06F 9/44; G06F 9/445

(52) U.S. Cl. 709/223; 717/173; 717/178

(57) ABSTRACT

Exemplary embodiments of the invention relate to a method, system, and storage medium for providing software and file distribution management. The method comprises loading a user profile for a client system into a server via an intelligent agent. The profile contains current software installed, files downloaded, and registered channels for the client system. The method also includes listening in to registered channels by an intelligent agent resident on the client system. If a new message is received, the method includes determining if the new message is applicable to the client system. The applicable messages result in querying the client system to execute a task based upon the message, executing the task in accordance with the client system's preferences, and updating a look-up system with the results of the task execution.

### BACKGROUND

The present invention relates generally to software and file management, and more particularly, to a method, system, and storage medium for providing intelligent distribution of software and files for computer and network systems.

Many businesses today expend a great deal of time and effort in maintaining and updating the software and exchanging files that are present in each of their computers. Some of the specific problems relating to software management include the time required to locate the appropriate software repository upon which to install/update the software, as well as the time required to perform the installation/update. Also, specific problems relate to difficulties in informing the end user of new documents or entertainment media that become available. Not all businesses utilize information technology experts, and for many businesses, the level of knowledge and skills possessed by computer maintenance personnel are limited. Furthermore, a company-wide installation or update of new software, as well as the systems employed to exchange files or documents, require a scalable solution from the server side.

Currently, the tasks associated with the installation and update of software, as well as the exchange of files or documents, are shared between technical support staff and/or employees themselves, or alternatively, in a consumer environment, the consumer himself. Because of frequent changes in software versions and the constant need to install and use new software or exchange new files and documents, the costs of maintaining a consistent software and files regime across a large company could be very high.

What is needed, therefore, is a systematic way to implement software installations and distribution of software and files for computer and network systems.

### SUMMARY

The foregoing discussed drawbacks and deficiencies of the prior art are overcome or alleviated by a method for providing software and file distribution management. Exemplary embodiments of the invention relate to a method, system, and storage medium for providing intelligent installation and distribution of software and file management. The method comprises loading a user profile for a client system into a server via an intelligent agent. The profile contains current software installed, required files downloaded, and registered channels for the client system. The method also includes listening in to registered channels by an intelligent agent resident on the client system. If a new message is received, the method includes determining if the new message is applicable to the client system. The applicable messages result in querying the client system to execute a task based upon the message, executing the task in accordance with the client system's preferences, and updating a look-up system with the results of the task execution.

In a further embodiment, a method for providing software and file distribution management includes listening in on a server for updated information relating to software, files, software providers, and file providers via a communications interface. If the updated information is detected, it is published to a look-up system for access by a client system, and a software provider associated with the updated information is allocated upon receiving a download request for software by the client system.

### BRIEF DESCRIPTION OF THE DRAWINGS

Turning now to the drawings wherein like elements are numbered alike in the several FIGURES:

FIG. 1 is a block diagram of a system upon which the software and file distribution management system may be implemented in an exemplary embodiment;

FIG. 2 is a flowchart describing a process of implementing the software and file distribution management tool by an intelligent agent resident on a computer client system in an exemplary embodiment; and

FIG. 3 is a flowchart describing a process of implementing the software and file distribution management tool by a software or file management administrator in an exemplary embodiment.

### DETAILED DESCRIPTION

The software and file distribution management system provides an automated service that assists businesses in maintaining computer software, files (e.g., documents, music, video, or other media). The system provides intelligent installation and distribution based upon user preferences and scheduled software or file downloads. The system provides the ability to maintain a unified information infrastructure, reduce the time spend on software maintenance by employees, as well as a system administrator or other technical staff, and reduce the expenses associated with providing technical support for software and file distribution management. Furthermore, the system optimizes the downloading of software or files by controlling the load balances associated with the real download process and the timing of new software or file notifications.

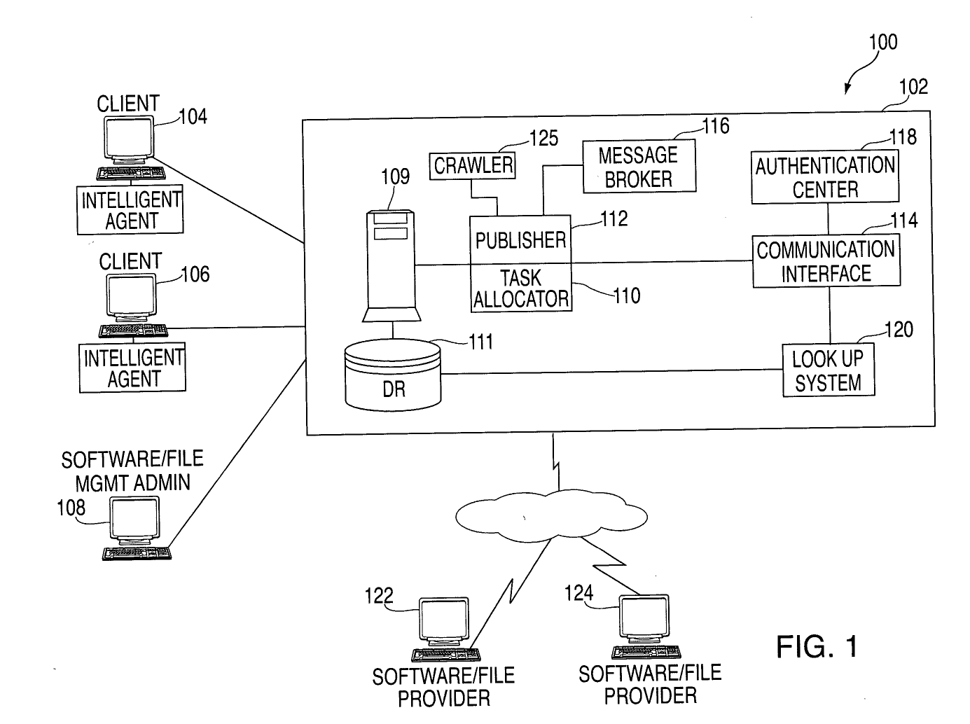

Referring now to FIG. 1, a system upon which the software and file distribution management system of the invention may be implemented is described. System 100 of FIG. 1 includes a host system 102 in communication with client systems 104 and 106, as well as with software or file management/administrator client system 108. Host system 102 is also in communication with software and file provider client systems 122 and 124 via a communications network such as the Internet to download required software or files.

Host system 102 includes a server 109 and data repository 111. Server 109 may be implemented as a web application hosted by an application server such as IBM's Websphere™. Server 109 further includes a task allocator 110, a publisher 112, and communications interface 114. The communications interface 114 may be implemented using web services or HTTP protocols. Server 109 also comprises a message broker 116 and authentication center 118. Data repository 111 includes a lookup system 120. These features are described further herein.

Task allocator 110 interacts with client systems 104 and 106 and receives download requests for services from them through communications interface 114. Task allocator 110 further allocates software or file download tasks based upon factors such as the locations of the respective software and file repositories, the operation system required by the software, and available times that are determined in accordance with a schedule specified by users of each client system. Task allocator 110 optimizes the download requests from client systems 104 and 106 based upon the time and access location of the client system. Task allocator 110 further controls the frequency of publishing new software or file update messages through crawler 125 based upon the loads of software/file service providers 122 and/or 124.

Publisher 112 receives information for publication from communications interface 114 or crawler 125 that are used for administration and publishes the information to the appropriate channels. A channel, as used herein, refers to a group of client system users 104, 106 that share common software and/or file requirements. Further, software and file distribution management administrators such as the administrator of client system 108 may update the status of new and existing software or files and their download locations or repositories.

Communications interface 114 also allows users to subscribe to specific channels defined in the look-up system 120.

Publisher 112 transmits published information to message broker 116. Message broker 116 publishes the messages to client systems that are listening in to registered channels. Publisher 112 also assembles the message in the format required by message broker 116.

Message broker 116 is a service that enables a system administrator or crawler 125 to ‘publish’ to channels on a server. Publishing does not occur until appropriate authentication from center 118 has been performed for a system administrator. Publishing is usually performed on a periodic basis for crawler 125.

Authentication center 118 is a third party component, which allows the system to authenticate the system administrator, as well as an end user from client systems 104, 106. Upon receiving a call from communication interface 114, the authentication verification request is sent to authentication center 118. Authentication center 118 returns a value of TRUE or FALSE, which confirms or denies the credentials of the user. If the authentication fails, the communication with the client system is terminated.

Look-up system 120 provides information about the software and file requirements for groups of users (i.e., channels). Look-up system 120 also stores a list of providers for each software product and file, as well as addresses for where the software and file is physically stored. Look-up system 120 may be implemented as a relational database management system (RDBMS) or lightweight directory access protocol (LDAP) or a file system.

Look-up system 120 stores the software and file information, the target audience information, and the information relating to the retrieval or download methods for each channel. Each channel has unique channel identification. For each channel, the stored software and file information includes characteristics for the required or optional software or files of the channel, such as version, software or file size, and operating system required for the software. Look-up system 120 also stores the channels that are registered by each end-user.

Look-up system 120 is stored in data repository 111. Data repository 111 may also store software or file information for use with the software and file distribution management system. File transfer protocol (FTP) servers may be used to interact directly between software/file providers and the individual intelligent agents as per the schedule assigned by task allocator 110.

Crawler 125 refers to a crawling task that is executed on a periodic basis (or based upon the inputs received from the software or file management/administrator at client system 108) to re-publish messages to the appropriate channel through publisher 112.

Client systems 104 and 106 refer to computer systems that utilize the services of the software and file distribution system. Software or file management/administrator client system 108 refers to a computer system that is operated by an administrator of the software and file distribution management system. Client systems 104-108 may comprise general-purpose computer devices, laptop devices, mobile computing devices, or other similar type of device. Each of client systems 104 and 106 further comprises an intelligent agent that resides at each system. Intelligent agents listen in on one more channels and receive information published on the channel(s) pertaining to a new software and/or file addition, the standard software requirement for the group, or a software or file update or deletion. The intelligent agents compare this information with the existing software installed or file downloaded on the client system and identify any needed installations or updates or deletions. The agent notifies the client system, receives the scheduling instructions, and then negotiates with task allocator 110 to schedule the installation and/or download and/or task update.

Each intelligent agent is responsible for registering itself into message broker 116. The intelligent agents further alert the respective client system 104, 106 of the availability of new software and/or new versions of software or file if applicable to the end user. The user on each client system 104, 106 then informs the respective intelligent agent whether or not the software should be installed or updated or whether a file should be downloaded, and if so, specifies the disk drive and time period for download and update. The intelligent agent then remembers the task and initiates the download/update if needed.

Software or file management/administrator client system 108 publishes information about software or file updates or new software/file providers on server 109 via communications interface 114 and publisher 112. The publisher 112 publishes messages to message broker 116.

Software/file provider systems 122 and 124 represent sources of software and/or hardware that are utilized by host system 102 and client systems 104, 106. Systems 122 and 124 provide new software, new versions of existing software, software patches, new or updated files, and devices for executing or facilitating execution of the software utilized by host system 102 and client systems 104, 106.

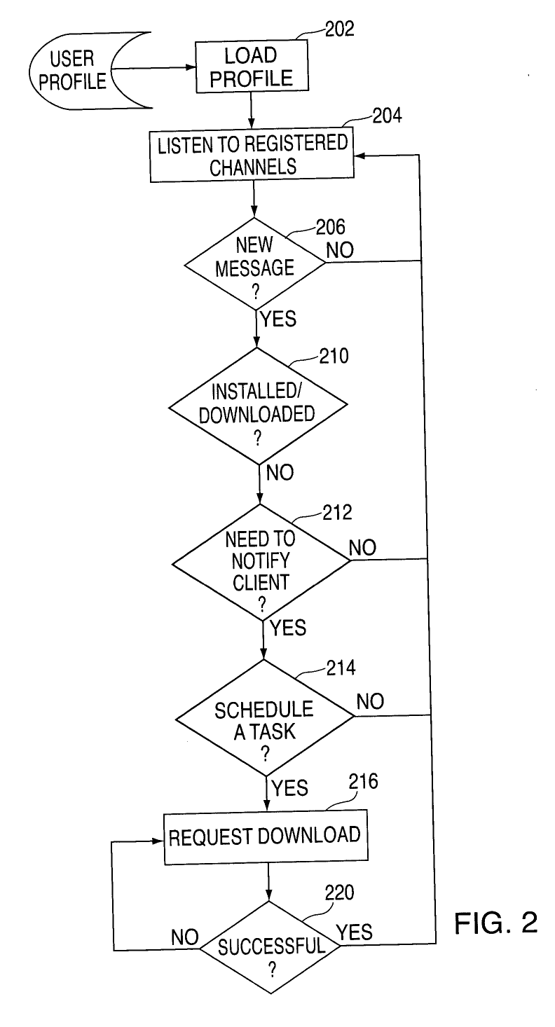

As described above, the software and file distribution management system provides certain automation to the maintenance, installation, and upgrade processes associated with groups (channels) of computer users. Intelligent agents resident on client systems 104 and 106 receive information about new or updated software or files and take action as described in FIG. 2.

At step 202, a user profile for an end user is loaded into client system 104 via an intelligent agent at the time when the intelligent agent is initiated. The profile contains the current software installed (or files downloaded) for the client system and the channels registered. The intelligent agent at client system 104 listens to registered channels at step 204. At step 206 it is determined whether there are any new messages (e.g., new updates, versions, software) that are required for the channel in which the client system belongs. If not, the process returns to step 204 and the listening continues. If there is a new message at step 206, the software and file distribution system determines whether the update, new software or files, etc., have already been installed at step 210. This may be performed by evaluating the current software or files resident on client system 104 by the intelligent agent.

If the software has been installed or the file has been downloaded at step 210, the process again reverts to step 204. Otherwise, the software and file distribution management system determines whether to notify the client system of the new message at step 212. This may be because the new software/file or updated software/file does not appear in the user's channel of required software or files. If it is determined that the client does not need to be notified at step 212, the process reverts back to step 204. Otherwise, the software and file distribution management system determines whether a task should be scheduled at step 214. The task refers to the activity that is to be performed as a result of the new message received. The task is typically a download of a new software application, an upgrade of an existing software application, a patch, or a file. This determination is made by notifying the user of client system 104 of the task and querying the user about executing the task. If the user does not wish to schedule the task at step 214, the process reverts to step 204. Otherwise, the task is scheduled and downloaded at step 216. At step 220, the software and file distribution management system checks to see if the download was successfully completed. If not, the download is again scheduled at step 216. If the download was successful at step 220, the process reverts to step 204.

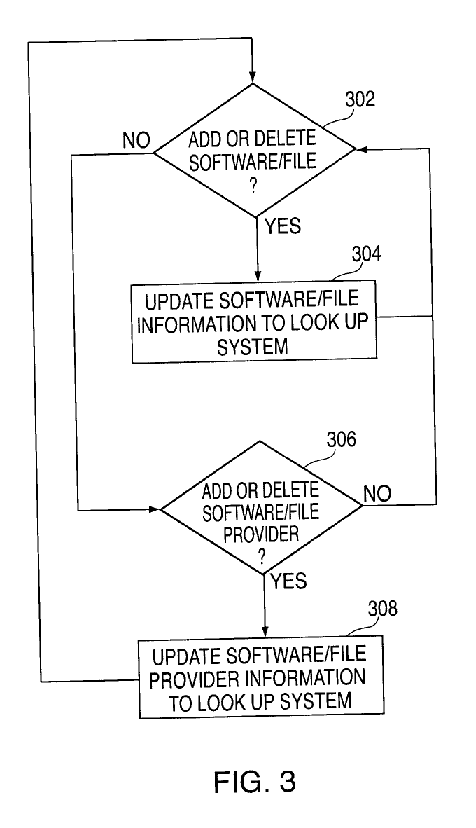

A software or file management/administrator at client system 108 performs administrative functions for client systems 104, 106 using the software and file distribution management tool as described in FIG. 3. An administrator connects to communications interface 114 and listens in for new software and/or file updates. As a result of the listening, it is determined whether new software or file is detected or if existing software or files should be deleted at step 302. If so, the administrator at client system 108 publishes the information in the look-up system 120 via publisher 112 and server 109 at step 304 and the process returns to step 302. If no new software or files (or existing software or files to be deleted) are detected at step 302, the process continues to step 306 where it is determined whether a new software/file provider is detected (or an existing software/file provider should be deleted). This may occur, for example, where a client system is upgraded with new hardware or peripheral devices that require new or different software. If a new software/file provider has been detected (or an existing provider should be deleted) at step 306, the information associated with the hardware (e.g., print driver software needed for a new printer) is updated in look-up system 120 at step 308 and the process returns to step 302. If, on the other hand, no new provider is detected (or alternatively, no existing providers should be deleted) at step 306, the process reverts to step 302.

As will be appreciated from the above description, the restrictions and limitations that exist with current software and file distribution management processes are efficiently overcome. The invention provides an automated service that assists businesses in maintaining, installing, and upgrading computer software, as well as distributing files. These services enable business enterprises in maintaining a unified information infrastructure and reducing the time and money spent on software or file maintenance by employees.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for providing software and file distribution management, comprising:
loading a user profile for an end user into a client system via an intelligent agent, said profile containing current software installed, files downloaded, and registered channels for said client system;
listening in to registered channels by an intelligent agent resident on said client system; and
if a new message is received, determining if said new message is applicable to said client system;
wherein applicable messages result in:
querying said client system to execute a task based upon said message;
executing said task in accordance with said client system's preferences; and
updating a look-up system with results of task execution.

2. The method of claim 1, wherein if said user profile does not exist:
creating at least one registered channel for said end user;
creating a user profile that includes said at least one registered channel; and
storing said user profile in a data repository accessible by said intelligent agent.

3. The method of claim 2, wherein said creating at least one registered channel includes:
basing a creation of said at least one registered channel on at least one of:
information retrieved from said look-up system, said information associated with said client system requirements; and
inputs received from said end user via said client system; and
storing said registered channel in said data repository.

4. The method of claim 1, wherein said listening in to registered channels by an intelligent agent comprises:
opening a communication connection to a message broker;
receiving said new message from said message broker;
reading a message header of said new message;
discarding said message based upon said reading a message header and upon an occurrence of at least one of:
said message header indicates that said new message is not associated with one of said registered channels;
software associated with said new message has already been installed on said client system;
an end user has requested that said software relating to said new message should not be installed; and
a file associated with said new message has already been downloaded.

5. The method of claim 1, wherein said registered channels include software and hardware requirements for groups of end users that share common software and hardware requirements.

6. The method of claim 1, wherein said new message includes information relating to at least one of:
a new software product;
a new version of an existing software product;
an obsolete software product;
a software product patch;
a new software provider;
an obsolete software provider;
a new file;
an updated file;
a new hardware device;
a new version of an existing hardware device;
an obsolete hardware device.

7. The method of claim 1, wherein said look-up system stores:
information relating to software or file requirements for said registered channels;
lists of providers of software products or files utilized by said client systems; and
addresses where software or files are physically stored.

8. A method for providing software and file distribution management, comprising:
listening in on a server for updated information relating to software, software providers, files, and file providers via a communications interface;
if said updated information is detected:
publishing said updated information to a look-up system for access by a client system; and
allocating a software provider or file provider associated with said updated information upon receiving a download request for software or files by said client system.

9. The method of claim 8, further comprising:
crawling said look-up system for said updated information based upon at least one of:
a pre-defined time interval for a crawling task; and
manual initiation of a crawling task.

10. The method of claim 9, wherein said crawling said look-up system includes:
composing a channel specific message relating to said updated information; and
publishing said channel specific message to a message broker operable for notifying client systems affected by said updated information.

11. The method of claim 8, wherein said allocating a software provider associated with said updated information includes:
selecting a software provider or file provider that is geographically closest to said client system when a plurality of software or file providers are detected and said plurality of software or file providers are not reserved beyond their capacities during a time slot requested for download by said client system;
if there is no software provider or file provider available, sending a message to said client system requesting said client system select a different time slot; and
if one software provider or file provider is selected and is available, reserving said time slot requested for download by said client system.

12. The method of claim 10, further comprising:
controlling a time interval of publishing said channel specific message to said registered channels via said message broker in a manner that increases or decreases an awareness of said updated information, said controlling operable for managing download requests from client systems and managing system loads.

13. A storage medium encoded with machine-readable computer program code for providing software and file distribution management, said storage medium including instructions for causing a computer to implement a method, comprising:
loading a user profile for an end user into a client system via an intelligent agent, said profile containing current software installed, files downloaded, and registered channels for said client system;
listening in to registered channels by an intelligent agent resident on said client system; and
if a new message is received, determining if said new message is applicable to said client system;
wherein applicable messages result in:
querying said client system to execute a task based upon said message;
executing said task in accordance with said client system's preferences; and
updating a look up system with results of task execution.

14. The storage medium of claim 13, wherein if said user profile does not exist:
creating at least one registered channel for said end user;
creating a user profile that includes said at least one registered channel; and
storing said user profile in a data repository accessible by said intelligent agent.

15. The storage medium of claim 14, wherein said creating at least one registered channel includes:
basing a creation of said at least one registered channel on at least one of:
information retrieved from said look-up system, said information associated with said client system requirements; and
inputs received from said end user via said client system; and
storing said registered channel in said data repository.

16. The storage medium of claim 13, wherein said listening in to registered channels by an intelligent agent comprises:
opening a communication connection to a message broker;
receiving said new message from said message broker;
reading a message header of said new message;
discarding said message based upon said reading a message header and upon an occurrence of at least one of:
said message header indicates that said new message is not associated with one of said registered channels;
software associated with said new message has already been installed on said client system;
an end user has requested that said software relating to said new message should not be installed; and
a file associated with said new message has already been downloaded.

17. The storage medium of claim 13, wherein said registered channels include software and hardware requirements for groups of end users that share common software and hardware requirements.

18. The storage medium of claim 13, wherein said new message includes information relating to at least one of:
a new software product;
a new version of an existing software product;
an obsolete software product;
a software product patch;
a new software provider;
an obsolete software provider;
a new file;
an updated file;
a new hardware device;
a new version of an existing hardware device;
an obsolete hardware device.

19. The storage medium of claim 13, wherein said look-up system comprises:
information relating to software requirements or file requirements for said registered channels;
lists of providers of software products or files utilized by said client systems; and
addresses where software or a file is physically stored.

20. A storage medium encoded with machine-readable computer program code for providing software and file distribution management, said storage medium including instructions for causing a server to implement a method, comprising:
listening in on a server for updated information relating to software, software providers, files, and file providers via a communications interface;
if said updated information is detected:
publishing said updated information to a look-up system for access by a client system; and
allocating a software provider or file provider associated with said updated information upon receiving a download request for software or a file by said client system.

21. The storage medium of claim 20, further comprising instructions for causing said server to implement:
crawling said look-up system for said updated information based upon at least one of:
a pre-defined time interval for a crawling task; and
manual initiation of a crawling task.

22. The storage medium of claim 21 wherein said crawling said look-up system includes:
composing a channel specific message relating to said updated information; and
publishing said channel specific message to a message broker operable for notifying client systems affected by said updated information.

23. The storage medium of claim 20, wherein said allocating a software provider associated with said updated information includes:
selecting a software provider or file provider that is geographically closest to said client system when a plurality of software providers are detected and said plurality of software providers are not reserved beyond their capacities during a time slot requested for download by said client system;
if there is no software provider or file provider available, sending a message to said client system requesting said client system select a different time slot; and
if one software provider or file provider is selected and is available, reserving said time slot requested for download by said client system.

24. The storage medium of claim 22, further comprising instructions for causing said server to implement:
controlling a time interval of publishing said channel specific message to said registered channels via said message broker in a manner that increases or decreases an awareness of said updated information, said controlling operable for managing download requests from client systems and managing system loads.

25. A system for providing software and file distribution management, comprising:
a client system;
a link to a server, said server including a communications interface;
an intelligent agent executing on said client system; wherein said intelligent agent performs:
loading a user profile for an end user into said client system, said profile containing current software installed, files downloaded, and registered channels for said client system;
listening in to said registered channels; and
if a new message is received, determining if said new message is applicable to said client system;
wherein applicable messages result in:
querying said client system to execute a task based upon said message;
executing said task in accordance with said client system's preferences; and
updating a look-up system with results of task execution via said communications interface.

26. The system of claim 25, wherein said look up system stores:
information relating to software requirements or file requirements for said registered channels;
lists of providers of software products or files utilized by said client system; and
addresses where software or a file is physically stored.

27. The system of claim 25, further comprising a link to a service provider wherein;
said executing a task in accordance with said client system's preferences includes performing at least one of:
downloading and installing new software;
downloading and installing a new version of existing software;
downloading and installing a patch for existing software;
downloading a file;
scheduling an installation for said new software;
scheduling an installation for said new version of existing software;
scheduling an installation for said patch;
scheduling a download for said file;
deleting existing software; and
scheduling deletion of said existing software.

28. A system for providing software and file distribution management, comprising:
a host system including:
a server in communication with a data repository;
a task allocator executing on said server;
a publisher executing on said server;
a crawler service executing via said publisher;
a communications interface; and
a look-up system stored in said data repository; and
a software or file management administrator client system in communication with said host system;
wherein an individual on said software or file management administrator client system performs:
listening in on said server for updated information relating to software, software providers, files, and file providers via said communications interface; and if said updated information is detected:
publishing said updated information to said look-up system for access by at least one client system; and
allocating a software provider or file provider associated with said updated information upon receiving a download request for software or files by said at least one client system.

29. The system of claim 28, wherein said task allocator allocates software download tasks and file download tasks based upon factors including at least one of:
a location of a repository associated with said download;
an operating system associated with said download, and
an available time that is determined in accordance with a schedule specified by an end user of a client system.

30. The system of claim 28, wherein said publisher receives information for publication from at least one of said communications interface and said crawler service and publishes said information to associated registered channels.
